(19) United States
(12) Patent Application Publication
(10) Pub. No.: US 2024/0360330 A1
(43) Pub. Date: Oct. 31, 2024

(54) ORGANIC SLURRY WITH GRADIENT VOLATILIZATION RATE AND PREPARATION METHOD

(71) Applicants: GRIREM ADVANCED MATERIALS CO., LTD., Beijing (CN); GRIREM HI-TECH CO., LTD., Langfang (CN)

(72) Inventors: Xiaojun SUN, Beijing (CN); Yang LUO, Beijing (CN); Zilong WANG, Beijing (CN); Dunbo YU, Beijing (CN); Jiyuan GUO, Beijing (CN); Jiping DUAN, Beijing (CN); Yan WANG, Beijing (CN); Yuanfei YANG, Beijing (CN); Hongbin ZHANG, Beijing (CN); Kaiwen WU, Beijing (CN)

(73) Assignees: GRIREM ADVANCED MATERIALS CO., LTD., Beijing (CN); GRIREM HI-TECH CO., LTD., Langfang (CN)

(21) Appl. No.: 18/624,935

(22) Filed: Apr. 2, 2024

(30) Foreign Application Priority Data
Apr. 28, 2023 (CN) 202310483432.1

(51) Int. Cl. C09D 11/037; C09D 11/033; C09D 11/104; C09D 11/107; C09D 11/14

(52) U.S. Cl. CPC C09D 11/037; C09D 11/033; C09D 11/104; C09D 11/107; C09D 11/14

(57) ABSTRACT

Disclosed are an organic slurry with a gradient volatilization rate and a preparation method. The organic slurry includes a rare earth powder, an organic solvent, a resin, a dispersant, and/or an anti-settling agent, and/or a synergist, weight percentages of which are as follows: rare earth powder 50%-90%; organic solvent 8%-50%; resin 0.4%-6%; dispersant 0%-5%; anti-settling agent 0%-3%; and synergist 0%-3%. The preparation method includes: weighing the rare earth powder, organic solvent, resin, dispersant, and/or anti-settling agent, and/or synergist by weight percentage; sequentially adding the weighed ingredients into a mixer, stirring at a constant temperature, and then cooling to room temperature to obtain an organic carrier; adding the organic carrier and the weighed rare earth powder into a vacuum high-speed disperser to obtain a crude organic slurry; and transferring the crude organic slurry to a gap adjustable three-roll grinder for grinding to obtain a fine organic slurry.

### CROSS-REFERENCE TO RELATED APPLICATIONS

This application claims priority to Chinese Patent Application No. 202310483432.1, filed on Apr. 28, 2023, the content of which is incorporated herein by reference in its entirety.

### TECHNICAL FIELD

The present application relates to the field of screen printing technology, in particular to an organic slurry with a gradient volatilization rate and a preparation method.

### BACKGROUND

Neodymium iron boron (NdFeB) permanent magnet materials have been widely used in many fields such as electronic information and medical industry since their discovery in the 1980s due to their excellent properties such as high residual magnetism, coercivity, and maximum magnetic energy product. In recent years, in order to meet the requirements of drive motors of new energy vehicles and direct drive permanent magnet units of wind driven generators for the properties of sintered neodymium iron boron magnets, grain boundary diffusion treatment is usually required for the magnets to improve their coercivity. Traditional grain boundary diffusion mostly uses heavy rare earth elements, fluorides, hydrides, oxides, alloys, and the like as diffusion sources, and uses sputtering, evaporation, electrophoresis, surface coating, impregnation, and the like to coat surfaces of magnets with the diffusion sources. The diffusion sources have low diffusion efficiency and high consumption, and lack a low-cost grain boundary diffusion process suitable for industrial large-scale stable production, which limits the development, application and promotion of high-end neodymium iron boron magnets.

In order to compensate for the shortcomings of existing grain boundary diffusion methods, screen printing technology has been applied in the neodymium iron boron industry. Screen printing depends on a silk screen perforated plate and a slurry which is scraped and printed onto a substrate through holes of the perforated plate. The screen printing integrates respective advantages of sputtering and surface coating methods, and has the characteristics of low cost, high production efficiency, easy implementation of automated production, and the like, so it is expected to develop into a mainstream process of neodymium iron boron grain boundary diffusion. As a raw material for screen printing, the slurry directly affects the printing and subsequent diffusion effects.

In existing technologies, the main method for producing a slurry is to disperse rare earth powder into an organic solution such as alcohol/acetone through stirring. The organic slurry hardly meets the requirements of slow room temperature volatilization rate and fast high temperature volatilization rate simultaneously. A fast room temperature volatilization rate leads to volatilization of a large amount of organic solvent in a printing process and an increase in the viscosity of the organic slurry, making it difficult to print. A slow high temperature volatilization rate not only increases drying time, but also causes flow of a coated film layer, ultimately leading to an uneven film layer and affecting diffusion effects.

### SUMMARY

The present application aims to provide an organic slurry with a gradient volatilization rate and a preparation method, for solving at least one of the above technical problems and achieving gradient volatilization of the slurry.

Embodiments of the present application are implemented as follows.

An organic slurry with a gradient volatilization rate includes a rare earth powder, an organic solvent, a resin, a dispersant, and/or an anti-settling agent, and/or a synergist, weight percentages of which are as follows:
rare earth powder 50%-90%;
organic solvent 8%-50%;
resin 0.4%-6%;
dispersant 0%-5%; and
anti-settling agent 0%-3%; and
synergist 0%-3%.

In a preferred embodiment of the present application, the rare earth powder in the organic slurries with a gradient volatilization rate includes one or two of a pure metal powder containing a heavy rare earth element, an alloy powder containing a heavy rare earth or light rare earth element, and a heavy rare earth powder of a hydride, fluoride or oxide containing a heavy rare earth element.

In a preferred embodiment of the present application, the pure metal powder in the organic slurry with a gradient volatilization rate comprises one or two or more of Tb, Dy, Ho, and Gd; and the alloy powder is RExMy by mass percentage, where RE is one or two or more of Tb, Dy, Ho, Gd, Pr, Nd, La, Ce, and Y; M is one or two or more of Ga, Cu, Al, Ni, and Fe; 60≤x≤95, and 5≤y≤40.

In a preferred embodiment of the present application, the rare earth powder in the organic slurry with a gradient volatilization rate has a particle size D50 of less than 3 μm.

In a preferred embodiment of the present application, the organic solvent in the organic slurry with a gradient volatilization rate comprises one or two or more of propylene glycol phenyl ether, DBE, methyl isobutyl ketone, and propylene glycol methyl ether acetate.

In a preferred embodiment of the present application, the resin in the organic slurry with a gradient volatilization rate includes one or two or more of ethyl cellulose, polyvinyl butyral, acrylic resin, vinyl chloride-vinyl acetate copolymer resin, polyester resin, and polyurethane.

A technical effect is as follows: the resin improves the adhesion of the organic slurry to a substrate, thereby ensuring subsequent grain boundary diffusion effects.

In a preferred embodiment of the present application, the dispersant in the organic slurry with a gradient volatilization rate includes one or two or more of polyvinyl butyral, polyvinyl pyrrolidone, sodium polyacrylate, and polyvinyl amide.

Technical effects are as follows: the dispersant can prevent re-aggregation of the diffusion source powder in the organic slurry, reduce the fineness of the organic slurry, and improve the consistency of weight gain during screen printing.

In a preferred embodiment of the present application, the anti-settling agent in the organic slurry with a gradient volatilization rate includes one or two or more of polyamide wax, polyethylene wax, organic bentonite, and fumed silica.

Technical effects are as follows: the anti-settling agent can improve the standing stability of the organic slurry, suppress the occurrence of a stratification phenomenon, and further reduce the room temperature volatilization rate.

In a preferred embodiment of the present application, the synergist in the organic slurry with a gradient volatilization rate is one or two or more of modified polyhydroxycarboxylate, BYK-SYNERGIST 2105, and BYK-SYNERGIST 2100.

A technical effect is as follows: the synergist can improve the reticular structure of an organic carrier.

In a preferred embodiment of the present application, the weight percentage of each ingredient in the organic slurry with a gradient volatilization rate is as follows:
pure metal powder 65%-75%;
one or two or more of propylene glycol phenyl ether, DBE, and propylene glycol methyl ether acetate 10%-30%;
one or two or more of ethyl cellulose, polyvinyl butyral, and polyester resin 0.4%-4%;
one or two or more of polyethylene glycol, polyethylene pyrrolidone, and polyethylene amide 0%-3%; and
one or two or more of modified polyhydroxycarboxylate, BYK-SYNERGIST 2105, and BYK-SYNERGIST 2100 0%-2%.

In a preferred embodiment of the present application, the weight percentage of each ingredient in the organic slurry with a gradient volatilization rate is as follows:
alloy powder 70%-80%;
one or two or more of propylene glycol phenyl ether, DBE, and propylene glycol methyl ether acetate 20%-30%;
one or two or more of acrylic resin, polyurethane, and polyester resin 0.4%-5%;
one or two or more of polyethylene glycol, polyethylene pyrrolidone, and polyethylene amide 0%-3%; and
one or two of polyamide wax and polyethylene wax 0%-2%; and
one or two or more of modified polyhydroxycarboxylate, BYK-SYNERGIST 2105, and BYK-SYNERGIST 2100 0%-2%.

In a preferred embodiment of the present application, the weight percentage of each ingredient in the organic slurry with a gradient volatilization rate is as follows:
heavy rare earth powder 60%-80%;
one or two of DBE and propylene glycol methyl ether acetate 10%-30%;
one or two or more of vinyl chloride-vinyl acetate copolymer resin, polyester resin, and polyurethane 0.4%-4%;
one or two or more of polyethylene glycol, polyethylene pyrrolidone, and polyethylene amide 0%-3%; and
one or two of polyamide wax and polyethylene wax 0%-2%; and
one or two or more of modified polyhydroxycarboxylate, BYK-SYNERGIST 2105, and BYK-SYNERGIST 2100 0%-2%.

A preparation method for the aforementioned organic slurry with a gradient volatilization rate includes:
weighing a rare earth powder, an organic solvent, a resin, a dispersant, and/or an anti-settling agent, and/or a synergist by weight percentage;
sequentially adding the weighed rare earth powder, organic solvent, resin, dispersant, and/or anti-settling agent, and/or synergist into a mixer, stirring at a constant temperature of 20-70° C. and a speed of 600 r/min-1200 r/min for 0.25-6 hours, and then cooling to room temperature to obtain an organic carrier, where a technical effect is as follows: the prepared organic carrier is uniform and free of floccules;
adding the organic carrier and the weighed rare earth powder into a vacuum high-speed disperser, and dispersing at a high speed of 1000 r/min-4000 r/min for 0.25-1 hour to obtain a crude organic slurry, where a technical effect is as follows: the prepared crude organic slurry has no bubbles and is uniformly dispersed; and
transferring the crude organic slurry to a gap adjustable three-roll grinder, and grinding 1-3 times to obtain a fine organic slurry.

A technical effect is as follows: the prepared fine organic slurry has a fineness of less than 5 μm.

The beneficial effects of the embodiments of the present application are as follows.

According to the organic slurry with a gradient volatilization rate and the preparation method of the present application, the organic carrier forms a reticular structure by constructing gradients of organic ingredients and by virtue of strong interaction of grinding, thereby ensuring that the room temperature volatilization rate is less than 0.05%/h and the high temperature volatilization rate is greater than 1.2%/h at 120° C., and achieving gradient volatilization of the slurry. The prepared organic slurry with a gradient volatilization rate has a low volatilization rate at room temperature, which can effectively prevent problems such as screen blockage and uneven printing caused by volatilization of the organic solvent during printing; and the organic slurry has a high volatilization rate and short curing time at a high temperature, which can significantly shorten drying time, improve processing efficiency, and reduce the content of oxygen, carbon, and other impurities entering a magnet in curing and subsequent heat treatment stages.

### BRIEF DESCRIPTION OF THE DRAWINGS

In order to illustrate the technical solutions of the embodiments of the present application more clearly, the accompanying drawings required for use in the embodiments will be introduce briefly below. It should be understood that the following drawings show only some embodiments of the present disclosure and should not be regarded as limiting the scope, and other relevant drawings can be derived based on the accompanying drawings by those of ordinary skill in the art without any creative efforts.

FIG. 1 is a schematic flowchart of a preparation method for an organic slurry with a gradient volatilization rate according to the present application.

FIG. 2 is a schematic diagram of volatilization curves of organic slurries with a gradient volatilization rate in examples of the present application under insulation at 40° C., 80° C., and 120° C. for 2 hours.

FIG. 3 is a schematic diagram of volatilization curves of organic slurries with a gradient volatilization rate in comparative examples of the present application under insulation at 40° C., 80° C., and 120° C. for 2 hours.

### DETAILED DESCRIPTION OF THE EMBODIMENTS

In order to make the objectives, technical solutions and advantages of the present application clearer, the following clearly and completely describes the technical solutions in the embodiments of the present application with reference to the accompanying drawings in the embodiments of the present application. Apparently, the described embodiments are some but not all of the embodiments of the present application. Generally, the components of the embodiments of the present application, described and shown in the accompanying drawings, can be arranged and designed with various different configurations.

A first embodiment of the present application provides an organic slurry with a gradient volatilization rate, including a rare earth powder, an organic solvent, a resin, a dispersant, and/or an anti-settling agent, and/or a synergist, weight percentages of which are as follows:
rare earth powder 50%-90%;
organic solvent 8%-50%;
resin 0.4%-6%;
dispersant 0%-5%; and
anti-settling agent 0%-3%; and
synergist 0%-3%.

Preferably, the weight percentage of each ingredient is as follows:
rare earth powder 60%-80%;
organic solvent 10%-30%;
resin 0.4%-5%;
dispersant 0%-3%;
anti-settling agent 0%-2%; and
synergist 0%-2%.

In a preferred embodiment of the present application, the rare earth powder in the organic slurries with a gradient volatilization rate includes one or two of a pure metal powder containing a heavy rare earth element, an alloy powder containing a heavy rare earth or light rare earth element, and a heavy rare earth powder of a hydride, fluoride or oxide containing a heavy rare earth element.

In a preferred embodiment of the present application, the pure metal powder in the organic slurry with a gradient volatilization rate includes one or two or more of Tb, Dy, Ho, and Gd.

The alloy powder is REₓM_{y} by mass percentage, where RE is one or two or more of Tb, Dy, Ho, Gd, Pr, Nd, La, Ce, and Y; M is one or two or more of Ga, Cu, Al, Ni, and Fe; 60≤x≤95, and 5≤y≤40.

In a preferred embodiment of the present application, the pure metal powder in the organic slurry with a gradient volatilization rate includes one or two of Tb and Dy.

The alloy powder is REₓM_{y} by mass percentage, where RE is one or two or more of Tb, Dy, Pr, and Nd. When RE is Tb, M is one or two or more of Ga, Cu, Al, and Ni, 70≤x≤90, and 10≤y≤30; when RE is Dy, M is one or two or more of Ni, Fe, and Ga, 60<x≤80, and 20≤y≤40; and when RE is two or three of Tb, Pr, and Nd, M is one or two of Cu and Al, 80≤x≤95, and 5≤y≤20. The added alloy element reduces the melting point of the diffusion source, changes diffusion from solid-liquid diffusion to liquid-liquid diffusion, and significantly improves diffusion efficiency. And the above alloy element diffused into a magnet is mostly distributed at a grain boundary to reduce magnetic exchange coupling between grains.

In a preferred embodiment of the present application, the rare earth powder in the organic slurry with a gradient volatilization rate has a particle size D50 of less than 3 μm.

Preferably, the particle size of the rare earth powder is 1.6<D50<2.4. When the particle size of the powder is within the range, excellent stability can be obtained without a serious decrease in preparation efficiency of the powder due to a small particle size of the powder.

In a preferred embodiment of the present application, the organic solvent in the organic slurry with a gradient volatilization rate comprises one or two or more of propylene glycol phenyl ether, DBE, methyl isobutyl ketone, and propylene glycol methyl ether acetate.

Preferably, the organic solvent is one or two or more of propylene glycol phenyl ether, DBE, and propylene glycol methyl ether acetate. The organic solvent is highly volatile at a high temperature, thereby improving the drying efficiency after screen printing, reducing the entry of impurities such as C and O into the interior of the magnet during grain boundary diffusion, and ensuring the performance of the magnet after diffusion.

In a preferred embodiment of the present application, the resin in the organic slurry with a gradient volatilization rate includes one or two or more of ethyl cellulose, polyvinyl butyral, acrylic resin, vinyl chloride-vinyl acetate copolymer resin, polyester resin, and polyurethane.

Preferably, the resin is one or two or more of polyvinyl butyral, vinyl chloride-vinyl acetate copolymer resin, polyester resin, and polyurethane. The resin has a high molecular weight, can significantly increase the viscosity of the organic slurry by a small amount of addition, has a low degree of thermal decomposition, and reduces the entry of C and O elements into the magnet during the grain boundary diffusion.

A technical effect is as follows: the resin improves the adhesion of the organic slurry to a substrate, thereby ensuring subsequent grain boundary diffusion effects.

In a preferred embodiment of the present application, the dispersant in the organic slurry with a gradient volatilization rate includes one or two or more of polyvinyl butyral, polyvinyl pyrrolidone, sodium polyacrylate, and polyvinyl amide.

Preferably, the dispersant is one or two or more of polyethylene glycol, polyethylene pyrrolidone, and polyethylene amide. The dispersant is easily soluble in the organic solvent, has good wetting property for the diffusion source powder, and is conducive to the dispersion of the diffusion source powder.

Technical effects are as follows: the dispersant can prevent re-aggregation of the diffusion source powder in the organic slurry, reduce the fineness of the organic slurry, and improve the consistency of weight gain during screen printing.

In a preferred embodiment of the present application, the anti-settling agent in the organic slurry with a gradient volatilization rate includes one or two or more of polyamide wax, polyethylene wax, organic bentonite, and fumed silica.

Preferably, the anti-settling agent includes one or two of polyamide wax and polyethylene wax. The anti-settling agent can be completely decomposed at a high temperature to reduce residual C on the surface of the magnet during high-temperature grain boundary diffusion. Technical effects are as follows: the anti-settling agent can improve the standing stability of the organic slurry, suppress the occurrence of a

stratification phenomenon, and further reduce the room temperature volatilization rate.

In a preferred embodiment of the present application, the synergist in the organic slurry with a gradient volatilization rate is one or two or more of modified polyhydroxycarboxylate, BYK-SYNERGIST 2105, and BYK-SYNERGIST 2100.

Preferably, the synergist is a modified polyhydroxycarboxylate. The added synergist can significantly improve the high-temperature drying speed of the organic slurry without affecting the room temperature volatilization rate, thereby ensuring the realization of a gradient volatilization rate.

A technical effect is as follows: the synergist can improve the reticular structure of an organic carrier.

In a preferred embodiment of the present application, the weight percentage of each ingredient in the organic slurry with a gradient volatilization rate is as follows:
pure metal powder 65%-75%;
one or two or more of propylene glycol phenyl ether, DBE, and propylene glycol methyl ether acetate 10%-30%;
one or two or more of ethyl cellulose, polyvinyl butyral, and polyester resin 0.4%-4%;
one or two or more of polyethylene glycol, polyethylene pyrrolidone, and polyethylene amide 0%-3%; and
one or two or more of modified polyhydroxycarboxylate, BYK-SYNERGIST 2105, and BYK-SYNERGIST 2100 0%-2%.

In a preferred embodiment of the present application, the weight percentage of each ingredient in the organic slurry with a gradient volatilization rate is as follows:
alloy powder 70%-80%;
one or two or more of propylene glycol phenyl ether, DBE, and propylene glycol methyl ether acetate 20%-30%;
one or two or more of acrylic resin, polyurethane, and polyester resin 0.4%-5%;
one or two or more of polyethylene glycol, polyethylene pyrrolidone, and polyethylene amide 0%-3%; and
one or two of polyamide wax and polyethylene wax 0%-2%; and
one or two or more of modified polyhydroxycarboxylate, BYK-SYNERGIST 2105, and BYK-SYNERGIST 2100 0%-2%.

In a preferred embodiment of the present application, the weight percentage of each ingredient in the organic slurry with a gradient volatilization rate is as follows:
heavy rare earth powder 60%-80%;
one or two of DBE and propylene glycol methyl ether acetate 10%-30%;
one or two or more of vinyl chloride-vinyl acetate copolymer resin, polyester resin, and polyurethane 0.4%-4%;
one or two or more of polyethylene glycol, polyethylene pyrrolidone, and polyethylene amide 0%-3%; and
one or two of polyamide wax and polyethylene wax 0%-2%; and
one or two or more of modified polyhydroxycarboxylate, BYK-SYNERGIST 2105, and BYK-SYNERGIST 2100 0%-2%.

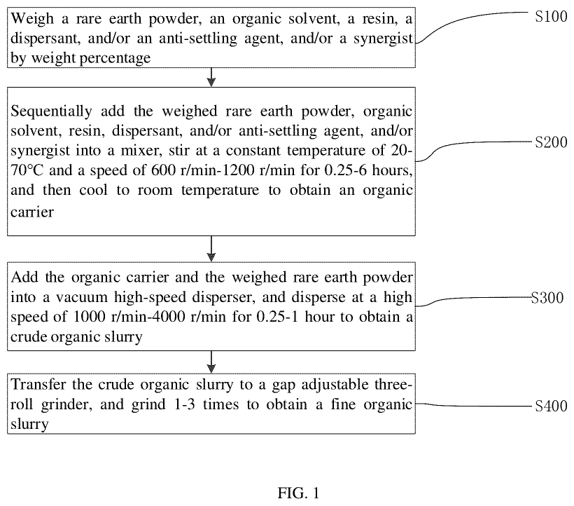

With reference to FIG. 1, a second embodiment of the present application provides a preparation method for the aforementioned organic slurry with a gradient volatilization rate, including:

S100: weighing a rare earth powder, an organic solvent, a resin, a dispersant, and/or an anti-settling agent, and/or a synergist by weight percentage;

S200: sequentially adding the weighed rare earth powder, organic solvent, resin, dispersant, and/or anti-settling agent, and/or synergist into a mixer, stirring at a constant temperature of 20-70° C. and a speed of 600 r/min-1200 r/min for 0.25-6 hours, and then cooling to room temperature to obtain an organic carrier, where a technical effect is as follows: the prepared organic carrier is uniform and free of floccules;

S300: adding the organic carrier and the weighed rare earth powder into a vacuum high-speed disperser, and dispersing at a high speed of 1000 r/min-4000 r/min for 0.25-1 hour to obtain a crude organic slurry, where a technical effect is as follows: the prepared crude organic slurry has no bubbles and is uniformly dispersed; and

S400: transferring the crude organic slurry to a gap adjustable three-roll grinder, and grinding 1-3 times to obtain a fine organic slurry.

A technical effect is as follows: the prepared fine organic slurry has a fineness of less than 5 μm.

Specifically, implementation effects of the present application will be further explained in detail through the following examples and comparative examples. Proportions of various ingredients in each example are shown in Table 1.

TABLE 1

| | Diffusion | | | | Anti- | |
|---|---|---|---|---|---|---|
| Serial | source | Organic | | | settling | |
| number | powder | solvent | Resin | Dispersant | agent | Synergist |
| 1 | 70% | 15% propylene | 1% vinyl | 2% | 0 | 0 |
| | Dy₈₀Ni₂₀ | glycol methyl | chloride- | sodium | | |
| | diffusion | ether acetate, | vinyl acetate | polyacrylate | | |
| | source | 10% DBE | copolymer | | | |
| | powder | | resin, 2% | | | |
| | | | polyester | | | |
| | | | resin | | | |
| 2 | 70% | 10% methyl | 2% acrylic | 0.4% | 3% | 2% BYK- |
| | Tb₈₃Cu₇Al₁₀ | isobutyl | resin | polyethylene | organic | SYNERGIST |
| | diffusion | ketone, 12% | | pyrrolidone, | bentonite | 2100 |
| | source | polyester resin | | 0.6% | | |
| | powder | | | polyethylene | | |
| | | | | amide | | |
| 3 | 70% Dy | 10% propylene | 3% polyester | 0 | 0 | 1% |
| | diffusion | glycol, 16% | resin | | | modified |
| | source | methyl ether | | | | polyhydroxycarboxylate |
| | powder | acetate | | | | |
| 4 | 70% | 11% methyl | 0.5% | 0.5% | 1% | 3% BYK- |
| | Pr₉₀Al₅Ga₅ | isobutyl | polyurethane, | polyethylene | polyamide | SYNERGIST |
| | diffusion | ketone, 11% | 1.5% | pyrrolidone, | wax, | 2105 |
| | source | polyester resin | polyester | 0.5% | 1% | |
| | powder | | resin | polyethylene | polyethylene | |
| | | | | amide | wax | |
| 5 | 70% | 12% propylene | 1% vinyl | 2% | 0 | 0.5% |
| | Dy₈₀Ni₂₀ | glycol methyl | chloride- | sodium | | modified |
| | diffusion | ether acetate, | vinyl acetate | polyacrylate | | polyhydroxycarboxylate |
| | source | 12.5% DBE | copolymer | | | |
| | powder | | resin, 2% | | | |
| | | | polyester | | | |
| | | | resin | | | |
| 6 | 60% TbH | 35% propylene | 5% ethyl | 0 | 0 | 0 |
| | diffusion | glycol phenyl | cellulose | | | |
| | source | ether | | | | |
| | powder | | | | | |
| 7 | 70% DyO | 23% propylene | 1% polyester | 1% | 0.5% | 2% BYK- |
| | | glycol methyl | resin | polyethylene | organic | SYNERGIST |
| | | ether acetate | | pyrrolidone | bentonite, | 2100 |
| | | | | | 1.5% | |
| | | | | | fumed | |
| | | | | | silica | |
| 8 | 90% TbH | 8% propylene | 2% ethyl | 0 | 0 | 0 |
| | diffusion | glycol phenyl | cellulose | | | |
| | source | ether | | | | |
| | powder | | | | | |
| 9 | 70% TbF | 12% propylene | 1.5% vinyl | 2% | 0 | 2.5% |
| | diffusion | glycol methyl | chloride- | sodium | | modified |
| | source | ether acetate, | vinyl acetate | polyacrylate | | polyhydroxycarboxylate |
| | powder | 10.5% DBE | copolymer | | | |
| | | | resin, 1.5% | | | |
| | | | polyester | | | |
| | | | resin | | | |
| 10 | 70% TbO | 20% propylene | 4% polyester | 1% | 0.5% | 2% BYK- |
| | | glycol methyl | resin | polyethylene | organic | SYNERGIST |
| | | ether acetate | | pyrrolidone | bentonite, | 2100 |
| | | | | | 1.5% | |
| | | | | | fumed | |
| | | | | | silica | |
| 11 | 70% Tb | 24% DBE | 4% polyvinyl | 1% | 0 | 1% |
| | diffusion | | butyral | polyethylene | | modified |
| | source | | | glycol | | polyhydroxycarboxylate |
| | powder | | | | | |
| 12 | 50% TbH | 44% propylene | 6% ethyl | 0 | 0 | 0 |
| | diffusion | glycol phenyl | cellulose | | | |
| | source | ether | | | | |
| | powder | | | | | |
| 13 | 70% Dy | 12% propylene | 3% polyester | 2% | 0 | 1% |
| | diffusion | glycol, 12% | resin | polyethylene | | modified |
| | source | methyl ether | | pyrrolidone | | polyhydroxycarboxylate |
| | powder | acetate | | | | |
| 14 | 70% Tb | 15% DBE + | 0.4% | 1% | 0 | 1% |
| | diffusion | 12.6% | polyvinyl | polyethylene | | modified |
| | source | polyurethane | butyral | glycol | | polyhydroxycarboxylate |
| | powder | | | | | |
| 15 | 70% TbF | 11% propylene | 1.5% vinyl | 2% | 0 | 2% |
| | diffusion | glycol methyl | chloride- | sodium | | modified |
| | source | ether acetate, | vinyl acetate | polyacrylate | | polyhydroxycarboxylate |
| | powder | 12% DBE | copolymer | | | |
| | | | resin, 1.5% | | | |
| | | | polyester | | | |
| | | | resin | | | |
| 16 | 70% | 10% propylene | 2% vinyl | 2% | 0 | 1.5% |
| | Tb₆₀Ni₄₀ | glycol methyl | chloride- | sodium | | modified |
| | diffusion | ether acetate, | vinyl acetate | polyacrylate | | polyhydroxycarboxylate |
| | source | 13.5% DBE | copolymer | | | |
| | powder | | resin, 1% | | | |
| | | | polyester | | | |
| | | | resin | | | |
| 17 | 70% TbO | 23% propylene | 1% polyester | 1% | 0.5% | 2% BYK- |
| | | glycol methyl | resin | polyethylene | organic | SYNERGIST |
| | | ether acetate | | pyrrolidone | bentonite, | 2100 |
| | | | | | 1.5% | |
| | | | | | fumed | |
| | | | | | silica | |
| 18 | 70% Dy | 9% propylene | 3% polyester | 5% | 0 | 1% |
| | diffusion | glycol, 12% | resin | polyethylene | | modified |
| | source | methyl ether | | pyrrolidone | | polyhydroxycarboxylate |
| | powder | acetate | | | | |
| 19 | 15% | 10% propylene | 2% polyester | 1% | 0.5% | 1.5% |
| | Tb₈₂Fe₁₈, | glycol, 12% | resin | polyethylene | organic | modified |
| | 25% | methyl ether | | pyrrolidone | bentonite | polyhydroxycarboxylate, |
| | La₈₀Al₂₀, | acetate | | | 1.5% | 1.5% |
| | 30% | | | | fumed | BYK- |
| | Ce₈₀Fe₂₀ | | | | silica | SYNERGIST |
| | diffusion | | | | | 2108 |
| | source | | | | | |
| | powders | | | | | |
| 20 | 5% | 10% propylene | 2% polyester | 1% | 1% | 2% |
| | Nd₉₀Cu₅Al₅, | glycol, 12% | resin | polyethylene | polyamide | modified |
| | 60% | methyl ether | | pyrrolidone | wax, | polyhydroxycarboxylate, |
| | Dy₉₀Cu₅Al₅, | acetate | | | 1% | 1% |
| | 5% TbF | | | | polyethylene | BYK- |
| | diffusion | | | | wax | SYNERGIST |
| | source | | | | | 2107 |
| | powders | | | | | |
| 21 | 5% | 22% methyl | 2% acrylic | 0.5% | 2% | 3% BYK- |
| | Nd₉₀Cu₅Al₅, | isobutyl ketone | resin | polyethylene | polyamide | SYNERGIST |
| | 50% | | | pyrrolidone, | wax | 2105 |
| | Dy₉₀Cu₅Al₅, | | | 0.5% | | |
| | 15% | | | polyethylene | | |
| | Dy₈₀Fe₂₀ | | | amide | | |
| | diffusion | | | | | |
| | source | | | | | |
| | powders | | | | | |
| 22 | 80% TbH | 17% propylene | 3% ethyl | 0 | 0 | 0 |
| | diffusion | glycol phenyl | cellulose | | | |
| | source | ether | | | | |
| | powder | | | | | |
| 23 | 10% Tb, | 10% methyl | 0.5% | 0.6% | 0.5% | 3% BYK- |
| | 20% | isobutyl | polyurethane, | polyethylene | polyamide | SYNERGIST |
| | Nd₉₀Cu₅Al₅, | ketone, 12% | 1.5% | pyrrolidone, | wax, | 2105 |
| | 40% | polyester resin | polyester | 0.4% | 1.5% | |
| | Tb₉₀Cu₅Ho₅ | | resin | polyethylene | polyethylene | |
| | diffusion | | | amide | wax | |
| | source | | | | | |
| | powders | | | | | |
| 24 | 70% | 22% methyl | 3% acrylic | 0.5% | 2% | 2% BYK- |
| | Tb₈₃Cu₇Al₁₀ | isobutyl ketone | resin | polyethylene | polyamide | SYNERGIST |
| | diffusion | | | pyrrolidone, | wax | 2100 |
| | source | | | 0.5% | | |
| | powder | | | polyethylene | | |
| | | | | amide | | |
| 25 | 70% TbF | 10% propylene | 2% vinyl | 2% | 0 | 3% |
| | diffusion | glycol methyl | chloride- | sodium | | modified |
| | source | ether acetate, | vinyl acetate | polyacrylate | | polyhydroxycarboxylate |
| | powder | 12% DBE | copolymer | | | |
| | | | resin, 1% | | | |
| | | | polyester | | | |
| | | | resin | | | |
| 26 | 70% Tb | 22% DBE | 6% polyvinyl | 1% | 0 | 1% |
| | diffusion | | butyral | polyethylene | | modified |
| | source | | | glycol | | polyhydroxycarboxylate |
| | powder | | | | | |
| 27 | 70% Tb | 23% DBE | 5% polyvinyl | 1% | 0 | 1% |
| | diffusion | | butyral | polyethylene | | modified |
| | source | | | glycol | | polyhydroxycarboxylate |
| | powder | | | | | |
| 28 | 70% Tb | 10% DBE + | 2% polyvinyl | 1% | 0 | 1% |
| | diffusion | 16% | butyral | polyethylene | | modified |
| | source | polyurethane | | glycol | | polyhydroxycarboxylate |
| | powder | | | | | |
| 29 | 70% | 11% propylene | 3% polyester | 2% | 0 | 1% |
| | Dy₈₀Ni₂₀ | glycol methyl | resin | polyethylene | | modified |
| | diffusion | ether acetate, | | pyrrolidone | | polyhydroxycarboxylate |
| | source | 12% DBE | | | | |
| | powder | | | | | |
| 30 | 70% Tb | 10% DBE + | 1% polyvinyl | 1% | 0 | 1% |
| | diffusion | 17% | butyral | polyethylene | | modified |
| | source | polyurethane | | glycol | | polyhydroxycarboxylate |
| | powder | | | | | |
| 31 | 70% | 22% methyl | 3% acrylic | 0.5% | 1% | 3% BYK- |
| | Tb₈₃Cu₇Al₁₀ | isobutyl ketone | resin | polyethylene | polyamide | SYNERGIST |
| | diffusion | | | pyrrolidone, | wax | 2100 |
| | source | | | 0.5% | | |
| | powder | | | polyethylene | | |
| | | | | amide | | |
| 32 | 70% TbO | 22% propylene | 2% polyester | 2% | 0.5% | 2% BYK- |
| | | glycol methyl | resin | polyethylene | organic | SYNERGIST |
| | | ether acetate | | pyrrolidone | bentonite | 2100 |
| | | | | | 1.5%, | |
| | | | | | fumed | |
| | | | | | silica | |
| 33 | 30% | 10% propylene | 0.5% vinyl | 1% | 2% | 1% |
| | Nd₉₀Cu₅Al₅, | glycol methyl | chloride- | sodium | polyamide | modified |
| | 20% | ether acetate, | vinyl acetate | polyacrylate | wax | polyhydroxycarboxylate, |
| | Y₈₀Fe₂₀, | 12% DBE | copolymer | | | 2% |
| | 20% Tb | | resin, 1.5% | | | BYK- |
| | diffusion | | polyester | | | SYNERGIST |
| | source | | resin | | | 2105 |
| | powders | | | | | |
| 34 | 70% DyO | 22% propylene | 2% polyester | 1% | 0.5% | 2% BYK- |
| | | glycol methyl | resin | polyethylene | organic | SYNERGIST |
| | | ether acetate | | pyrrolidone | bentonite | 2100 |
| | | | | | 1.5%, | |
| | | | | | fumed | |
| | | | | | silica | |
| 35 | 70% | 11% propylene | 2% vinyl | 2% | 0 | 1% |
| | Dy₈₀Ni₂₀ | glycol methyl | chloride- | sodium | | modified |
| | diffusion | ether acetate, | vinyl acetate | polyacrylate | | polyhydroxycarboxylate |
| | source | 13% DBE | copolymer | | | |
| | powder | | resin, 1% | | | |
| | | | polyester | | | |
| | | | resin | | | |
| 36 | 70% DyO | 20% propylene | 4% polyester | 1% | 0.5% | 2% BYK- |
| | | glycol methyl | resin | polyethylene | organic | SYNERGIST |
| | | ether acetate | | pyrrolidone | bentonite, | 2100 |
| | | | | | 1.5% | |
| | | | | | fumed | |
| | | | | | silica | |
| 37 | 70% Dy | 11% propylene | 3% polyester | 3% | 0 | 1% |
| | diffusion | glycol, 12% | resin | polyethylene | | modified |
| | source | methyl ether | | pyrrolidone | | polyhydroxycarboxylate |
| | powder | acetate | | | | |
| 38 | 10% | 11% propylene | 1% vinyl | 1% | 2% | 1% |
| | Nd₉₀Cu₅Al₅, | glycol methyl | chloride- | sodium | polyamide | modified |
| | 40% | ether acetate, | vinyl acetate | polyacrylate | wax | polyhydroxycarboxylate, |
| | Dy₉₀Cu₅Al₅, | 11% DBE | copolymer | | | 2% |
| | 20% | | resin, 1% | | | BYK- |
| | Dy₈₀Fe₂₀ | | polyester | | | SYNERGIST |
| | diffusion | | resin | | | 2106 |
| | source | | | | | |
| | powders | | | | | |
| 39 | 70% Dy | 10% propylene | 3% polyester | 4% | 0 | 1% |
| | diffusion | glycol, 12% | resin | polyethylene | | modified |
| | source | methyl ether | | pyrrolidone | | polyhydroxycarboxylate |
| | powder | acetate | | | | |
| 40 | 70% TbH | 26% propylene | 4% ethyl | 0 | 0 | 0 |
| | diffusion | glycol phenyl | cellulose | | | |
| | source | ether | | | | |
| | powder | | | | | |
| 41 | 70% Dy | 15% propylene | 3% polyester | 1% | 0 | 1% |
| | diffusion | glycol, 10% | resin | polyethylene | | modified |
| | source | methyl ether | | pyrrolidone | | polyhydroxycarboxylate |
| | powder | acetate | | | | |
| 42 | 70% Tb | 25% DBE | 3% polyvinyl | 1% | 0 | 1% |
| | diffusion | | butyral | polyethylene | | modified |
| | source | | | glycol | | polyhydroxycarboxylate |
| | powder | | | | | |

### Example 1

70% of Dy₈₀Ni₂₀ diffusion source powder, 15% of propylene glycol methyl ether acetate, 10% of DBE, 1% of vinyl chloride-vinyl acetate copolymer resin, 2% of polyester resin, and 2% of sodium polyacrylate were weighed by weight percentage, where the Dy₈₀Ni₂₀ diffusion source powder had a particle size D50 of 2.83 μm;

The propylene glycol methyl ether acetate, DBE, vinyl chloride-vinyl acetate copolymer resin, polyester resin, and sodium polyacrylate were sequentially added into a mixer and stirred at a constant temperature of 60° C. and a speed of 1200 r/min for 5 hours to obtain a uniform and non-flocculent organic carrier;

The Dy₈₀Ni₂₀ diffusion source powder and the prepared organic carrier were added into a vacuum high-speed disperser and dispersed at a high speed of 2200 r/min for 25 minutes to preliminarily prepare an organic slurry; and then the organic slurry obtained by the high-speed dispersion was transferred to a three-roll grinder and ground twice to obtain an organic slurry having a fineness of less than 5 μm.

### Example 2

70% of Tb₈₃Cu₇Al₁₀ diffusion source powder, 10% of methyl isobutyl ketone, 12% of polyester resin, 2% of acrylic resin, 0.4% of polyethylene pyrrolidone, 0.6% of polyethylene amide, 3% of organic bentonite, and 2% of BYK-SYNERGIST 2100 were weighed by weight percentage, where the Tb₈₃Cu₇Al₁₀ diffusion source powder had a particle size D50 of 2.54 μm;

The methyl isobutyl ketone, polyester resin, acrylic resin, polyethylene pyrrolidone, polyethylene amide, organic bentonite, and BYK-SYNERGIST 2100 were sequentially added into a mixer and stirred at a constant temperature of 25° C. and a speed of 1000 r/min for 25 minutes to obtain a uniform and non-flocculent organic carrier;

The Tb₈₀Cu₁₀Al₁₀ diffusion source powder and the prepared organic carrier were added into a vacuum high-speed disperser and dispersed at a high speed of 2200 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 3

70% of Dy diffusion source powder, 10% of propylene glycol, 16% of methyl ether acetate, 3% of polyester resin, and 1% of modified polyhydroxycarboxylate were weighed by weight percentage, where the Dy diffusion source powder had a particle size D50 of 2.31 μm;

The propylene glycol, methyl ether acetate, polyester resin, and modified polyhydroxycarboxylate were sequentially added into a mixer and stirred at a constant temperature of 50° C. and a speed of 900 r/min for 6 hours to obtain a uniform and non-flocculent organic carrier;

The Dy diffusion source powder and the prepared organic carrier were added into a vacuum high-speed disperser and dispersed at a high speed of 2300 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 4

70% of Pr₉₀Al₅Ga₅ diffusion source powder, 11% of methyl isobutyl ketone, 11% of polyester resin, 0.5% of polyurethane, 1.5% of polyester resin, 0.5% of polyethylene pyrrolidone, 0.5% of polyethylene amide, 1% of polyamide wax, 1% of polyethylene wax, and 3% of BYK-SYNERGIST 2105 were weighed by weight percentage, where the Pr₉₀Al₅Ga₅ diffusion source powder had a particle size D50 of 1.89 μm;

The methyl isobutyl ketone, polyester resin, polyurethane, polyester resin, polyethylene pyrrolidone, polyethylene amide, polyamide wax, polyethylene wax, and BYK-SYNERGIST 2105 were sequentially added into a mixer and stirred at a constant temperature of 30° C. and a speed of 1000 r/min for 1 hour to obtain a uniform and non-flocculent organic carrier;

The Pr₉₀Cu₅Ga₅ diffusion source powder and the prepared organic carrier were added into a vacuum high-speed disperser and dispersed at a high speed of 2200 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 5

70% of Dy₈₀Ni₂₀ diffusion source powder, 12% of propylene glycol methyl ether acetate, 12.5% of DBE, 1% of vinyl chloride-vinyl acetate copolymer resin, 2% of polyester resin, 2% of sodium polyacrylate, and 0.5% of modified polyhydroxycarboxylate were weighed by weight percentage, where the Dy₈₀Ni₂₀ diffusion source powder had a particle size D50 of 2.5 μm;

The propylene glycol methyl ether acetate, DBE, vinyl chloride-vinyl acetate copolymer resin, polyester resin, sodium polyacrylate, and modified polyhydroxycarboxylate were sequentially added into a mixer and stirred at a constant temperature of 60° C. and a speed of 1000 r/min for 6 hours to obtain a uniform and non-flocculent organic carrier;

The Dy₈₀Ni₂₀ diffusion source powder and the prepared organic carrier were added into a vacuum high-speed disperser and dispersed at a high speed of 2200 r/min for 25 minutes to preliminarily prepare an organic slurry; and then the organic slurry obtained by the high-speed dispersion was transferred to a three-roll grinder and ground three times to obtain an organic slurry having a fineness of less than 5 μm.

### Example 6

60% of Tb—H diffusion source powder, 35% of propylene glycol phenyl ether, and 5% of ethyl cellulose were weighed by weight percentage, where the Tb—H diffusion source powder had a particle size D50 of 1.99 μm;

The propylene glycol phenyl ether and the ethyl fiber were sequentially added into a mixer and stirred at a constant temperature of 25° C. and a speed of 900 r/min for 15 minutes to obtain a uniform and non-flocculent organic carrier;

The Tb—H diffusion source powder and the prepared organic carrier were added into a vacuum high-speed disperser and dispersed at a high speed of 2000 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 7

70% of DyO diffusion source powder, 23% of propylene glycol methyl ether acetate, 1% of polyester resin, 1% of polyethylene pyrrolidone, 0.5% of organic bentonite, 1.5% of fumed silica, and 2% of BYK-SYNERGIST 2100 were weighed by weight percentage, where the DyO diffusion source powder had a particle size D50 of 2.27 μm;

The propylene glycol methyl ether acetate, polyester resin, polyvinyl pyrrolidone, organic bentonite, fumed silica, and BYK-SYNERGIST 2100 were sequentially added into a mixer and stirred at a constant temperature of 55° C. and a speed of 1000 r/min for 4 hours to obtain a uniform and non-flocculent organic carrier;

The DyO diffusion source powder and the prepared organic carrier were added into a vacuum high-speed disperser and dispersed at a high speed of 2200 r/min for 30 minutes to preliminarily prepare an organic slurry; and then the organic slurry obtained by the high-speed dispersion was transferred to a three-roll grinder and ground three times to obtain an organic slurry having a fineness of less than 5 μm.

### Example 8

90% of TbH diffusion source powder, 8% of propylene glycol phenyl ether, and 2% of ethyl cellulose were weighed by weight percentage, where the Tb—H diffusion source powder had a particle size D50 of less than 2.5 μm;

The propylene glycol phenyl ether and the ethyl fiber were sequentially added into a mixer and stirred at a constant temperature of 25° C. and a speed of 900 r/min for 15 minutes to obtain a uniform and non-flocculent organic carrier;

The Tb—H diffusion source powder and the prepared organic carrier were added into a vacuum high-speed disperser and dispersed at a high speed of 2500 r/min for 50 minutes to preliminarily prepare an organic slurry; and then the organic slurry obtained by the high-speed dispersion was transferred to a three-roll grinder and ground twice to obtain an organic slurry having a fineness of less than 5 μm.

### Example 9

70% of TbF diffusion source powder, 12% of propylene glycol methyl ether acetate, 10.5% of DBE, 1.5% of vinyl chloride-vinyl acetate copolymer resin, 1.5% of polyester resin, 2% of sodium polyacrylate, and 2.5% of modified polyhydroxycarboxylate were weighed by weight percentage, where the TbF diffusion source powder had a particle size D50 of 2.33 μm;

The propylene glycol methyl ether acetate, DBE, vinyl chloride-vinyl acetate copolymer resin, polyester resin, sodium polyacrylate, and modified polyhydroxycarboxylate were sequentially added into a mixer and stirred at a constant temperature of 55° C. and a speed of 1000 r/min for 5 hours to obtain a uniform and non-flocculent organic carrier;

The TbF diffusion source powder and the prepared organic carrier were added into a vacuum high-speed disperser and dispersed at a high speed of 2200 r/min for 25 minutes to preliminarily prepare an organic slurry; and then the organic slurry obtained by the high-speed dispersion was transferred to a three-roll grinder and ground three times to obtain an organic slurry having a fineness of less than 5 μm.

### Example 10

70% of TbO diffusion source powder, 20% of propylene glycol methyl ether acetate, 4% of polyester resin, 1% of polyethylene pyrrolidone, 0.5% of organic bentonite, 1.5% of fumed silica, and 2% of BYK-SYNERGIST 2100 were weighed by weight percentage, where the TbO diffusion source powder had a particle size D50 of 2.17 μm;

The propylene glycol methyl ether acetate, polyester resin, polyvinyl pyrrolidone, organic bentonite, fumed silica, and BYK-SYNERGIST 2100 were sequentially added into a mixer and stirred at a constant temperature of 60° C. and a speed of 1000 r/min for 5.5 hours to obtain a uniform and non-flocculent organic carrier;

The TbO metal powder and the prepared organic carrier were added into a vacuum high-speed disperser and dispersed at a high speed of 2200 r/min for 40 minutes to preliminarily prepare an organic slurry; and then the organic slurry obtained by the high-speed dispersion was transferred to a three-roll grinder and ground three times to obtain an organic slurry having a fineness of less than 5 μm.

### Example 11

70% of Tb diffusion source powder, 24% of DBE, 4% of polyvinyl butyral, 1% of polyethylene glycol, and 1% of modified polyhydroxycarboxylate were weighed by weight percentage, where the Tb diffusion source powder had a particle size D50 of 1.63 μm;

The DBE, polyvinyl butyral, polyethylene glycol, and modified polyhydroxycarboxylate were sequentially added into a mixer and stirred at a constant temperature of 25° C. and a speed of 900 r/min for 15 minutes to obtain a uniform and non-flocculent organic carrier;

The Tb diffusion source powder and the prepared organic carrier were added into a vacuum high-speed disperser and dispersed at a high speed of 2000 r/min for 15 minutes to preliminarily prepare an organic slurry; and then the organic slurry obtained by the high-speed dispersion was transferred to a three-roll grinder and ground once to obtain an organic slurry having a fineness of less than 5 μm.

### Example 12

50% of Tb—H diffusion source powder, 44% of propylene glycol phenyl ether, and 6% of ethyl cellulose were weighed by weight percentage, where the Tb—H diffusion source powder had a particle size D50 of 2.43 μm;

The propylene glycol phenyl ether and the ethyl fiber were sequentially added into a mixer and stirred at a constant temperature of 25° C. and a speed of 900 r/min for 15 minutes to obtain a uniform and non-flocculent organic carrier;

The Tb—H diffusion source powder and the prepared organic carrier were added into a vacuum high-speed disperser and dispersed at a high speed of 2000 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 13

70% of Dy diffusion source powder, 12% of propylene glycol, 12% of methyl ether acetate, 3% of polyester resin, 2% of polyvinyl pyrrolidone, and 1% of modified polyhydroxycarboxylate were weighed by weight percentage, where the Dy diffusion source powder had a particle size D50 of 1.67 μm;

The propylene glycol, methyl ether acetate, polyester resin, polyvinyl pyrrolidone, and modified polyhydroxycarboxylate were sequentially added into a mixer and stirred at a constant temperature of 45° C. and a speed of 1000 r/min for 6 hours to obtain a uniform and non-flocculent organic carrier;

The Dy diffusion source powder and the prepared organic carrier were added into a vacuum high-speed disperser and dispersed at a high speed of 2300 r/min for 25 minutes to preliminarily prepare an organic slurry; and then the organic slurry obtained by the high-speed dispersion was transferred to a three-roll grinder and ground twice to obtain an organic slurry having a fineness of less than 5 μm.

### Example 14

70% of Tb diffusion source powder, 15% of DBE, 12.6% of polyurethane, 0.4% of polyvinyl butyral, 1% of polyethylene glycol, and 1% of modified polyhydroxycarboxylate were weighed by weight percentage, where the Tb diffusion source powder had a particle size D50 of 1.84 μm;

The DBE, polyvinyl butyral, polyethylene glycol, and modified polyhydroxycarboxylate were sequentially added into a mixer and stirred at a constant temperature of 25° C. and a speed of 900 r/min for 20 minutes to obtain a uniform and non-flocculent organic carrier;

The Tb diffusion source powder and the prepared organic carrier were added into a vacuum high-speed disperser and dispersed at a high speed of 2200 r/min for 30 minutes to preliminarily prepare an organic slurry; and then the organic slurry obtained by the high-speed dispersion was transferred to a three-roll grinder and ground once to obtain an organic slurry having a fineness of less than 5 μm.

### Example 15

70% of TbF diffusion source powder, 11% of propylene glycol methyl ether acetate, 12% of DBE, 1.5% of vinyl chloride-vinyl acetate copolymer resin, 1.5% of polyester resin, 2% of sodium polyacrylate, and 2% of modified polyhydroxycarboxylate were weighed by weight percentage, where the TbF diffusion source powder had a particle size D50 of 2.45 μm;

The propylene glycol methyl ether acetate, DBE, vinyl chloride-vinyl acetate copolymer resin, polyester resin, sodium polyacrylate, and modified polyhydroxycarboxylate were sequentially added into a mixer and stirred at a constant temperature of 70° C. and a speed of 1200 r/min for 5 hours to obtain a uniform and non-flocculent organic carrier;

The TbF diffusion source powder and the prepared organic carrier were added into a vacuum high-speed disperser and dispersed at a high speed of 2200 r/min for 40 minutes to preliminarily prepare an organic slurry; and then the organic slurry obtained by the high-speed dispersion was transferred to a three-roll grinder and ground once to obtain an organic slurry having a fineness of less than 5 μm.

### Example 16

70% of Tb₆₀Ni₄₀ diffusion source powder, 10% of propylene glycol methyl ether acetate, 13.5% of DBE, 2% of vinyl chloride-vinyl acetate copolymer resin, 1% of polyester resin, 2% of sodium polyacrylate, and 1.5% of modified polyhydroxycarboxylate were weighed by weight percentage, where the Tb₆₀Ni₄₀ diffusion source powder had a particle size D50 of 2.25 μm;

The propylene glycol methyl ether acetate, DBE, vinyl chloride-vinyl acetate copolymer resin, polyester resin, sodium polyacrylate, and modified polyhydroxycarboxylate were sequentially added into a mixer and stirred at a constant temperature of 65° C. and a speed of 1200 r/min for 5 hours to obtain a uniform and non-flocculent organic carrier;

The Tb₆₀Ni₄₀ diffusion source powder and the prepared organic carrier were added into a vacuum high-speed disperser and dispersed at a high speed of 2200 r/min for 25 minutes to preliminarily prepare an organic slurry; and then the organic slurry obtained by the high-speed dispersion was transferred to a three-roll grinder and ground twice to obtain an organic slurry having a fineness of less than 5 μm.

### Example 17

70% of TbO diffusion source powder, 23% of propylene glycol methyl ether acetate, 1% of polyester resin, 1% of polyethylene pyrrolidone, 0.5% of organic bentonite, 1.5% of fumed silica, and 2% of BYK-SYNERGIST 2100 were weighed by weight percentage, where the TbO diffusion source powder had a particle size D50 of less than 3 μm;

The propylene glycol methyl ether acetate, polyester resin, polyvinyl pyrrolidone, organic bentonite, fumed silica, and BYK-SYNERGIST 2100 were sequentially added into a mixer and stirred at a constant temperature of 45° C. and a speed of 1000 r/min for 4 hours to obtain a uniform and non-flocculent organic carrier;

The TbO diffusion source powder and the prepared organic carrier were added into a vacuum high-speed disperser and dispersed at a high speed of 2200 r/min for 35 minutes to preliminarily prepare an organic slurry; and then the organic slurry obtained by the high-speed dispersion was transferred to a three-roll grinder and ground twice to obtain an organic slurry having a fineness of less than 5 μm.

### Example 18

70% of Dy diffusion source powder, 9% of propylene glycol, 12% of methyl ether acetate, 3% of polyester resin, 5% of polyvinyl pyrrolidone, and 1% of modified polyhydroxycarboxylate were weighed by weight percentage, where the Dy diffusion source powder had a particle size D50 of 2.46 μm;

The propylene glycol, methyl ether acetate, polyester resin, polyvinyl pyrrolidone, and modified polyhydroxycarboxylate were sequentially added into a mixer and stirred at a constant temperature of 55° C. and a speed of 1200 r/min for 5 hours to obtain a uniform and non-flocculent organic carrier;

The Dy diffusion source powder and the prepared organic carrier were added into a vacuum high-speed disperser and dispersed at a high speed of 2300 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 19

5% of Tb₈₂Fe₁₈, 25% of La₈₀Al₂₀, and 30% of Ce₈₀Fe₂₀ diffusion source powders, 10% of propylene glycol, 12% of methyl ether acetate, 2% of polyester resin, 1% of polyethylene pyrrolidone, 0.5% of organic bentonite, 1.5% of fumed silica, 1.5% of modified polyhydroxycarboxylate, and 1.5% of BYK-SYNERGIST 2100 were weighed by weight percentage, where the Tb₈₂Fe₁₈, La₈₀Al₂₀, and Ce₈₀Fe₂₀ diffusion source powders had particle sizes D50 of 2.33 μm, 2.17 μm, and 2.48 μm, respectively;

The propylene glycol, methyl ether acetate, polyester resin, polyvinyl pyrrolidone, organic bentonite, fumed silica, modified polyhydroxycarboxylate, and BYK-SYNERGIST 2100 were sequentially added into a mixer and stirred at a constant temperature of 55° C. and a speed of 1000 r/min for 5 hours to obtain a uniform and non-flocculent organic carrier;

The Tb₈₂Fe₁₈, La₈₀Al₂₀, and Ce₈₀Fe₂₀ diffusion source powders and the prepared organic carrier were added into a vacuum high-speed disperser and dispersed at a high speed of 2200 r/min for 30 minutes to preliminarily prepare an organic slurry; and then the organic slurry obtained by the high-speed dispersion was transferred to a three-roll grinder and ground once to obtain an organic slurry having a fineness of less than 5 μm.

### Example 20

5% of Nd₉₀Cu₅Al₅, 60% of Dy₉₀Cu₅Al₅, 5% of TbF diffusion source powders, 10% of propylene glycol methyl ether acetate, 12% of methyl isobutyl ketone, 2% of polyester resin, 1% of polyethylene pyrrolidone, 1% of polyamide wax, 1% of polyethylene wax, 2% of modified polyhydroxycarboxylate, and 1% of BYK-SYNERGIST 2100 were weighed by weight percentage, where the Nd₉₀Cu₅Al₅, Dy₉₀Cu₅Al₅, and TbF diffusion source powders had particle sizes D50 of 1.73 μm, 2.07 μm, and 1.88 μm, respectively;

The propylene glycol methyl ether acetate, methyl isobutyl ketone, polyester resin, polyvinyl pyrrolidone, polyamide wax, polyethylene wax, modified polyhydroxycarboxylate, and BYK-SYNERGIST 2100 were sequentially added into a mixer and stirred at a constant temperature of 55° C. and a speed of 1000 r/min for 5 hours to obtain a uniform and non-flocculent organic carrier;

The Nd₉₀Cu₅Al₅, Dy₉₀Cu₅Al₅, and TbF diffusion source powders and the prepared organic carrier were added into a vacuum high-speed disperser and dispersed at a high speed of 2200 r/min for 30 minutes to preliminarily prepare an organic slurry; and then the organic slurry obtained by the high-speed dispersion was transferred to a three-roll grinder and ground once to obtain an organic slurry having a fineness of less than 5 μm.

### Example 21

5% of Nd₉₀Cu₅Al₅, 50% of Dy₉₀Cu₅Al₅, and 15% of Dy₈₀Fe₂₀ diffusion source powders, 22% of methyl isobutyl ketone, 2% of acrylic resin, 0.5% of polyethylene pyrrolidone, 0.5% of polyethylene amide, 2% of polyamide wax, and 3% of BYK-SYNERGIST 2105 were weighed by weight percentage, where the Nd₉₀Cu₅Al₅, Dy₉₀Cu₅Al₅, and Dy₈₀Fe₂₀ diffusion source powders had particle sizes D50 of 2.02 μm, 2.13 μm, and 2.27 μm, respectively;

The methyl isobutyl ketone, acrylic resin, polyethylene pyrrolidone, polyethylene amide, polyamide wax, and BYK-SYNERGIST 2105 were sequentially added into a mixer and stirred at a constant temperature of 25° C. and a speed of 1000 r/min for 20 minutes to obtain a uniform and non-flocculent organic carrier;

The Nd₉₀Cu₅Al₅, Dy₉₀Cu₅Al₅, and Dy₈₀Fe₂₀ diffusion source powders and the prepared organic carrier were added into a vacuum high-speed disperser and dispersed at a high speed of 2200 r/min for 40 minutes to preliminarily prepare an organic slurry; and then the organic slurry obtained by the high-speed dispersion was transferred to a three-roll grinder and ground twice to obtain an organic slurry having a fineness of less than 5 μm.

### Example 22

80% of Tb—H diffusion source powder, 17% of propylene glycol phenyl ether, and 3% of ethyl cellulose were weighed by weight percentage, where the Tb—H diffusion source powder had a particle size D50 of 1.67 μm;

The propylene glycol phenyl ether and the ethyl fiber were sequentially added into a mixer and stirred at a constant temperature of 25° C. and a speed of 900 r/min for 15 minutes to obtain a uniform and non-flocculent organic carrier;

The Tb—H diffusion source powder and the prepared organic carrier were added into a vacuum high-speed disperser and dispersed at a high speed of 2000 r/min for 45 minutes to preliminarily prepare an organic slurry; and then the organic slurry obtained by the high-speed dispersion was transferred to a three-roll grinder and ground three times to obtain an organic slurry having a fineness of less than 5 μm.

### Example 23

10% of Tb, 20% of Nd₉₀Cu₅Al₅, 40% of Tb₉₀Cu₅Ho₅ diffusion source powders, 10% of methyl isobutyl ketone, 12% of polyester resin, 0.5% of polyurethane, 1.5% of polyester resin, 0.6% of polyethylene pyrrolidone, 0.4% of polyethylene amide, 0.5% of polyamide wax, 1.5% of polyethylene wax, and 3% of BYK-SYNERGIST 2105 were weighed by weight percentage, where the Tb, Nd₉₀Cu₅Al₅, and Tb₉₀Cu₅Ho₅ diffusion source powders had particle sizes D50 of 1.45 μm, 1.56 μm, and 1.73 μm, respectively;

The methyl isobutyl ketone, polyester resin, polyurethane, polyester resin, polyethylene pyrrolidone, polyethylene amide, polyamide wax, polyethylene wax, and BYK-SYNERGIST 2105 were sequentially added into a mixer and stirred at a constant temperature of 70° C. and a speed of 1200 r/min for 6 hour to obtain a uniform and non-flocculent organic carrier;

The Tb, Nd₉₀Cu₅Al₅, and Tb₉₀Cu₅Ho₅ diffusion source powders and the prepared organic carrier were added into a vacuum high-speed disperser and dispersed at a high speed of 2200 r/min for 25 minutes to preliminarily prepare an organic slurry; and then the organic slurry obtained by the high-speed dispersion was transferred to a three-roll grinder and ground three times to obtain an organic slurry having a fineness of less than 5 μm.

### Example 24

70% of Tb₈₀Cu₁₀Al₁₀ diffusion source powder, 22% of methyl isobutyl ketone, 3% of acrylic resin, 0.5% of polyethylene pyrrolidone, 0.5% of polyethylene amide, 2% of polyamide wax, and 2% of BYK-SYNERGIST 2100 were weighed by weight percentage, where the Tb₈₀Cu₁₀Al₁₀ diffusion source powder had a particle size D50<=2.17 μm;

The propylene methyl isobutyl ketone, acrylic resin, polyethylene pyrrolidone, polyethylene amide, polyamide wax, and BYK-SYNERGIST 2100 were sequentially added into a mixer and stirred at a constant temperature of 25° C. and a speed of 1000 r/min for 25 minutes to obtain a uniform and non-flocculent organic carrier;

The Tb₈₀Cu₁₀Al₁₀ diffusion source powder and the prepared organic carrier were added into a vacuum high-speed disperser and dispersed at a high speed of 2200 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 25

70% of TbF diffusion source powder, 10% of propylene glycol methyl ether acetate, 12% of DBE, 2% of vinyl chloride-vinyl acetate copolymer resin, 1% of polyester resin, 2% of sodium polyacrylate, and 3% of modified polyhydroxycarboxylate were weighed by weight percentage, where the TbF diffusion source powder had a particle size D50 of 2.36 μm;

The propylene glycol methyl ether acetate, DBE, vinyl chloride-vinyl acetate copolymer resin, polyester resin, sodium polyacrylate, and modified polyhydroxycarboxylate were sequentially added into a mixer and stirred at a constant temperature of 55° C. and a speed of 1200 r/min for 4 hours to obtain a uniform and non-flocculent organic carrier;

The TbF diffusion source powder and the prepared organic carrier were added into a vacuum high-speed disperser and dispersed at a high speed of 2200 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 26

70% of Tb diffusion source powder, 22% of DBE, 6% of polyvinyl butyral, 1% of polyethylene glycol, and 1% of modified polyhydroxycarboxylate were weighed by weight percentage, where the Tb diffusion source powder had a particle size D50 of 2.53 μm;

The DBE, polyvinyl butyral, polyethylene glycol, and modified polyhydroxycarboxylate were sequentially added into a mixer and stirred at a constant temperature of 25° C. and a speed of 1000 r/min for 30 minutes to obtain a uniform and non-flocculent organic carrier;

The Tb diffusion source powder and the prepared organic carrier were added into a vacuum high-speed disperser and dispersed at a high speed of 2000 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 27

70% of Tb diffusion source powder, 23% of DBE, 5% of polyvinyl butyral, 1% of polyethylene glycol, and 1% of modified polyhydroxycarboxylate were weighed by weight percentage, where the Tb diffusion source powder had a particle size D50 of 1.93 μm;

The DBE, polyvinyl butyral, polyethylene glycol, and modified polyhydroxycarboxylate were sequentially added into a mixer and stirred at a constant temperature of 25° C. and a speed of 900 r/min for 25 minutes to obtain a uniform and non-flocculent organic carrier;

The Tb diffusion source powder and the prepared organic carrier were added into a vacuum high-speed disperser and dispersed at a high speed of 2000 r/min for 25 minutes to preliminarily prepare an organic slurry; and then the organic slurry obtained by the high-speed dispersion was transferred to a three-roll grinder and ground twice to obtain an organic slurry having a fineness of less than 5 μm.

### Example 28

70% of Tb diffusion source powder, 10% of DBE, 16% of polyurethane, 2% of polyvinyl butyral, 1% of polyethylene glycol, and 1% of modified polyhydroxycarboxylate were weighed by weight percentage, where the Tb diffusion source powder had a particle size D50 of 2.07 μm;

The DBE, polyvinyl butyral, polyethylene glycol, and modified polyhydroxycarboxylate were sequentially added into a mixer and stirred at a constant temperature of 25° C. and a speed of 600 r/min for 40 minutes to obtain a uniform and non-flocculent organic carrier;

The Tb diffusion source powder and the prepared organic carrier were added into a vacuum high-speed disperser and dispersed at a high speed of 2200 r/min for 35 minutes to preliminarily prepare an organic slurry; and then the organic slurry obtained by the high-speed dispersion was transferred to a three-roll grinder and ground once to obtain an organic slurry having a fineness of less than 5 μm.

### Example 29

70% of Dy₈₀Ni₂₀ diffusion source powder, 11% of propylene glycol methyl ether acetate, 12% of DBE, 3% of polyester resin, 2% of polyethylene pyrrolidone, and 1% of modified polyhydroxycarboxylate were weighed by weight percentage, where the Dy₈₀Ni₂₀ diffusion source powder had a particle size D50 of 2.5 μm;

The propylene glycol methyl ether acetate, DBE, polyester resin, polyethylene pyrrolidone, and modified polyhydroxycarboxylate were sequentially added into a mixer and stirred at a constant temperature of 55° C. and a speed of 1000 r/min for 4 hours to obtain a uniform and non-flocculent organic carrier;

The Dy₈₀Ni₂₀ diffusion source powder and the prepared organic carrier were added into a vacuum high-speed disperser and dispersed at a high speed of 2200 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 30

70% of Tb diffusion source powder, 10% of DBE, 17% of polyurethane, 1% of polyvinyl butyral, 1% of polyethylene glycol, and 1% of modified polyhydroxycarboxylate were weighed by weight percentage, where the Tb diffusion source powder had a particle size D50 of 2.36 μm;

The DBE, polyvinyl butyral, polyethylene glycol, and modified polyhydroxycarboxylate were sequentially added into a mixer and stirred at a constant temperature of 25° C. and a speed of 900 r/min for 20 minutes to obtain a uniform and non-flocculent organic carrier;

The Tb diffusion source powder and the prepared organic carrier were added into a vacuum high-speed disperser and dispersed at a high speed of 2200 r/min for 30 minutes to preliminarily prepare an organic slurry; and then the organic slurry obtained by the high-speed dispersion was transferred to a three-roll grinder and ground twice to obtain an organic slurry having a fineness of less than 5 μm.

### Example 31

70% of Tb₈₀Cu₁₀Al₁₀ diffusion source powder, 22% of methyl isobutyl ketone, 3% of acrylic resin, 0.5% of polyethylene pyrrolidone, 0.5% of polyethylene amide, 1% of polyamide wax, and 3% of BYK-SYNERGIST 2100 were weighed by weight percentage, where the Tb₈₀Cu₁₀Al₁₀ diffusion source powder had a particle size D50 of 1.91 μm;

The propylene methyl isobutyl ketone, acrylic resin, polyethylene pyrrolidone, polyethylene amide, polyamide wax, and BYK-SYNERGIST 2100 were sequentially added into a mixer and stirred at a constant temperature of 25° C. and a speed of 1000 r/min for 25 minutes to obtain a uniform and non-flocculent organic carrier;

The Tb₈₀Cu₁₀Al₁₀ diffusion source powder and the prepared organic carrier were added into a vacuum high-speed disperser and dispersed at a high speed of 2200 r/min for 45 minutes to preliminarily prepare an organic slurry; and then the organic slurry obtained by the high-speed dispersion was transferred to a three-roll grinder and ground three times to obtain an organic slurry having a fineness of less than 5 μm.

### Example 32

70% of TbO diffusion source powder, 22% of propylene glycol methyl ether acetate, 2% of polyester resin, 2% of polyethylene pyrrolidone, 0.5% of organic bentonite, 1.5% of fumed silica, and 2% of BYK-SYNERGIST 2100 were weighed by weight percentage, where the TbO diffusion source powder had a particle size D50 of less than 2.38 μm;

The propylene glycol methyl ether acetate, polyester resin, polyvinyl pyrrolidone, organic bentonite, fumed silica, and BYK-SYNERGIST 2100 were sequentially added into a mixer and stirred at a constant temperature of 45° C. and a speed of 1000 r/min for 4 hours to obtain a uniform and non-flocculent organic carrier;

The TbO diffusion source powder and the prepared organic carrier were added into a vacuum high-speed disperser and dispersed at a high speed of 2200 r/min for 30 minutes to preliminarily prepare an organic slurry; and then the organic slurry obtained by the high-speed dispersion was transferred to a three-roll grinder and ground three times to obtain an organic slurry having a fineness of less than 5 μm.

### Example 33

30% of Nd₉₀Cu₅Al₅, 20% of Y₈₀Fe₂₀, and 20% of Tb diffusion source powders, 10% of propylene glycol methyl ether acetate, 12% of DBE, 0.5% of vinyl chloride-vinyl acetate copolymer resin, 1.5% of polyester resin, 1% of acrylic resin, 2% of polyamide wax, 1% of modified polyhydroxycarboxylate, and 2% of BYK-SYNERGIST 2105 were weighed by weight percentage, where the Nd₉₀Cu₅Al₅, Y₈₀Fe₂₀, and Tb diffusion source powders had particle sizes D50 of 1.67 μm, 1.85 μm, and 2.02 μm, respectively;

The propylene glycol methyl ether acetate, DBE, vinyl chloride-vinyl acetate copolymer resin, polyester resin, acrylic resin, polyamide wax, modified polyhydroxycarboxylate, and BYK-SYNERGIST 2105 were sequentially added into a mixer and stirred at a constant temperature of 55° C. and a speed of 1200 r/min for 3 hours to obtain a uniform and non-flocculent organic carrier;

The Nd₉₀Cu₅Al₅, Y₈₀Fe₂₀, and Tb diffusion source powders and the prepared organic carrier were added into a vacuum high-speed disperser and dispersed at a high speed of 2200 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 34

70% of DyO diffusion source powder, 22% of propylene glycol methyl ether acetate, 4% of polyester resin, 2% of polyethylene pyrrolidone, 0.5% of organic bentonite, 1.5% of fumed silica, and 2% of BYK-SYNERGIST 2100 were weighed by weight percentage, where the DyO diffusion source powder had a particle size D50 of 2.32 μm;

The propylene glycol methyl ether acetate, polyester resin, polyvinyl pyrrolidone, organic bentonite, fumed silica, and BYK-SYNERGIST 2100 were sequentially added into a mixer and stirred at a constant temperature of 55° C. and a speed of 1000 r/min for 5 hours to obtain a uniform and non-flocculent organic carrier;

The DyO diffusion source powder and the prepared organic carrier were added into a vacuum high-speed disperser and dispersed at a high speed of 2200 r/min for 30 minutes to preliminarily prepare an organic slurry; and then the organic slurry obtained by the high-speed dispersion was transferred to a three-roll grinder and ground once to obtain an organic slurry having a fineness of less than 5 μm.

### Example 35

70% of Dy₈₀Ni₂₀ diffusion source powder, 11% of propylene glycol methyl ether acetate, 13% of DBE, 2% of vinyl chloride-vinyl acetate copolymer resin, 1% of polyester resin, 2% of sodium polyacrylate, and 1% of modified polyhydroxycarboxylate were weighed by weight percentage, where the Tb₈₀Ni₂₀ diffusion source powder had a particle size D50 of 1.99 μm;

The propylene glycol methyl ether acetate, DBE, vinyl chloride-vinyl acetate copolymer resin, polyester resin, sodium polyacrylate, and modified polyhydroxycarboxylate were sequentially added into a mixer and stirred at a constant temperature of 65° C. and a speed of 1200 r/min for 6 hours to obtain a uniform and non-flocculent organic carrier;

The Dy₈₀Ni₂₀ diffusion source powder and the prepared organic carrier were added into a vacuum high-speed disperser and dispersed at a high speed of 2200 r/min for 45 minutes to preliminarily prepare an organic slurry; and then the organic slurry obtained by the high-speed dispersion was transferred to a three-roll grinder and ground twice to obtain an organic slurry having a fineness of less than 5 μm.

### Example 36

70% of DyO diffusion source powder, 20% of propylene glycol methyl ether acetate, 4% of polyester resin, 1% of polyethylene pyrrolidone, 0.5% of organic bentonite, 1.5% of fumed silica, and 2% of BYK-SYNERGIST 2100 were weighed by weight percentage, where the DyO diffusion source powder had a particle size D50 of 2.35 μm;

The propylene glycol methyl ether acetate, polyester resin, polyvinyl pyrrolidone, organic bentonite, fumed silica, and BYK-SYNERGIST 2100 were sequentially added into a mixer and stirred at a constant temperature of 79° C. and a speed of 1200 r/min for 6 hours to obtain a uniform and non-flocculent organic carrier;

The TbO metal powder and the prepared organic carrier were added into a vacuum high-speed disperser and dispersed at a high speed of 2200 r/min for 30 minutes to preliminarily prepare an organic slurry; and then the organic slurry obtained by the high-speed dispersion was transferred to a three-roll grinder and ground once to obtain an organic slurry having a fineness of less than 5 μm.

### Example 37

70% of Dy diffusion source powder, 11% of propylene glycol, 12% of methyl ether acetate, 3% of polyester resin, 3% of polyvinyl pyrrolidone, and 1% of modified polyhydroxycarboxylate were weighed by weight percentage, where the Dy diffusion source powder had a particle size D50 of 1.96 μm;

The propylene glycol, methyl ether acetate, polyester resin, polyvinyl pyrrolidone, and modified polyhydroxycarboxylate were sequentially added into a mixer and stirred at a constant temperature of 70° C. and a speed of 900 r/min for 5 hours to obtain a uniform and non-flocculent organic carrier;

The Dy diffusion source powder and the prepared organic carrier were added into a vacuum high-speed disperser and dispersed at a high speed of 2300 r/min for 25 minutes to preliminarily prepare an organic slurry; and then the organic slurry obtained by the high-speed dispersion was transferred to a three-roll grinder and ground twice to obtain an organic slurry having a fineness of less than 5 μm.

### Example 38

10% of Nd₉₀Cu₅Al₅, 40% of Dy₉₀Cu₅Al₅, 20% of Dy₈₀Fe₂₀ diffusion source powders, 11% of propylene glycol methyl ether acetate, 11% of DBE, 1% of vinyl chloride-vinyl acetate copolymer resin, 1% of polyester resin, 1% of acrylic resin, 2% of polyamide wax, 1% of modified polyhydroxycarboxylate, and 2% of BYK-SYNERGIST 2105 were weighed by weight percentage, where the Nd₉₀Cu₅Al₅, Dy₉₀Cu₅Al₅, and Dy₈₀Fe₂₀ diffusion source powders had particle sizes D50 of 2.34 μm, 2.47 μm, and 2.35 μm, respectively;

The propylene glycol methyl ether acetate, DBE, vinyl chloride-vinyl acetate copolymer resin, polyester resin, acrylic resin, polyamide wax, modified polyhydroxycarboxylate, and BYK-SYNERGIST 2105 were sequentially added into a mixer and stirred at a constant temperature of 55° C. and a speed of 1000 r/min for 5 hours to obtain a uniform and non-flocculent organic carrier;

The Nd₉₀Cu₅Al₅, Dy₉₀Cu₅Al₅, and Dy₈₀Fe₂₀ diffusion source powders and the prepared organic carrier were added into a vacuum high-speed disperser and dispersed at a high speed of 2200 r/min for 35 minutes to preliminarily prepare an organic slurry; and then the organic slurry obtained by the high-speed dispersion was transferred to a three-roll grinder and ground once to obtain an organic slurry having a fineness of less than 5 μm.

### Example 39

70% of Dy diffusion source powder, 10% of propylene glycol, 12% of methyl ether acetate, 3% of polyester resin, 4% of polyvinyl pyrrolidone, and 1% of modified polyhydroxycarboxylate were weighed by weight percentage, where the Dy diffusion source powder had a particle size D50 of 1.97 μm;

The propylene glycol, methyl ether acetate, polyester resin, polyvinyl pyrrolidone, and modified polyhydroxycarboxylate were sequentially added into a mixer and stirred at a constant temperature of 55° C. and a speed of 1000 r/min for 4.5 hours to obtain a uniform and non-flocculent organic carrier;

The Dy diffusion source powder and the prepared organic carrier were added into a vacuum high-speed disperser and dispersed at a high speed of 2300 r/min for 25 minutes to preliminarily prepare an organic slurry; and then the organic slurry obtained by the high-speed dispersion was transferred to a three-roll grinder and ground three times to obtain an organic slurry having a fineness of less than 5 μm.

### Example 40

70% of Tb—H diffusion source powder, 26% of propylene glycol phenyl ether, and 4% of ethyl cellulose were weighed by weight percentage, where the Tb—H diffusion source powder had a particle size D50 of 1.64 μm;

The propylene glycol phenyl ether and the ethyl fiber were sequentially added into a mixer and stirred at a constant temperature of 25° C. and a speed of 600 r/min for 15 minutes to obtain a uniform and non-flocculent organic carrier;

The Tb—H diffusion source powder and the prepared organic carrier were added into a vacuum high-speed disperser and dispersed at a high speed of 2000 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Example 41

70% of Dy diffusion source powder, 15% of propylene glycol, 10% of methyl ether acetate, 3% of polyester resin, 1% of polyethylene pyrrolidone, and 1% of modified polyhydroxycarboxylate were weighed by weight percentage, where the Dy diffusion source powder had a particle size D50 of 2.06 μm;

The propylene glycol, methyl ether acetate, polyester resin, polyvinyl pyrrolidone, and modified polyhydroxycarboxylate were sequentially added into a mixer and stirred at a constant temperature of 45° C. and a speed of 1200 r/min for 6 hours to obtain a uniform and non-flocculent organic carrier;

The Dy diffusion source powder and the prepared organic carrier were added into a vacuum high-speed disperser and dispersed at a high speed of 2300 r/min for 25 minutes to preliminarily prepare an organic slurry; and then the organic slurry obtained by the high-speed dispersion was transferred to a three-roll grinder and ground twice to obtain an organic slurry having a fineness of less than 5 μm.

### Example 42

70% of Tb diffusion source powder, 25% of DBE, 3% of polyvinyl butyral, 1% of polyethylene glycol, and 1% of modified polyhydroxycarboxylate were weighed by weight percentage, where the Tb diffusion source powder had a particle size D50 of 2.08 μm;

The DBE, polyvinyl butyral, polyethylene glycol, and modified polyhydroxycarboxylate were sequentially added into a mixer and stirred at a constant temperature of 25° C. and a speed of 900 r/min for 20 minutes to obtain a uniform and non-flocculent organic carrier;

The Tb diffusion source powder and the prepared organic carrier were added into a vacuum high-speed disperser and dispersed at a high speed of 2000 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Comparative Example 1

60% of Tb diffusion source powder, 35.7% of anhydrous ethanol, 2% of polyvinyl butyral, 1% of polyvinyl pyrrolidone, 1% of polyamide wax, and 0.3% of modified polyhydroxycarboxylate were weighed by weight percentage, where the Tb diffusion source powder had a particle size D50 of less than 3 μm;

The anhydrous ethanol, polyvinyl butyral, polyvinyl pyrrolidone, polyamide wax, and modified polyhydroxycarboxylate were sequentially added into a mixer and stirred at a constant temperature of 25° C. and a speed of 900 r/min for 15 minutes to obtain a uniform and non-flocculent organic carrier;

The Tb diffusion source powder and the prepared organic carrier were added into a vacuum high-speed disperser and dispersed at a high speed of 2000 r/min for 25 minutes to preliminarily prepare an organic slurry; and then the organic slurry obtained by the high-speed dispersion was transferred to a three-roll grinder and ground once to obtain an organic slurry having a fineness of less than 5 μm.

### Comparative Example 2

80% of TbNi diffusion source powder, 17.5% of acetone, 1.5% of polyvinyl butyral, and 1% of polyethylene glycol were weighed by weight percentage, where the TbNi diffusion source powder had a particle size D50 of less than 3 μm;

The acetone, polyvinyl butyral, and polyethylene glycol were sequentially added into a mixer and stirred at a constant temperature of 25° C. and a speed of 1000 r/min for 20 minutes to obtain a uniform and non-flocculent organic carrier;

The weighed TbNi diffusion source powder and the prepared organic carrier were added into a vacuum high-speed disperser and dispersed at a high speed of 2200 r/min for 15 minutes to preliminarily prepare an organic slurry; and then the organic slurry obtained by the high-speed dispersion was transferred to a three-roll grinder and ground once to obtain an organic slurry having a fineness of less than 5 μm.

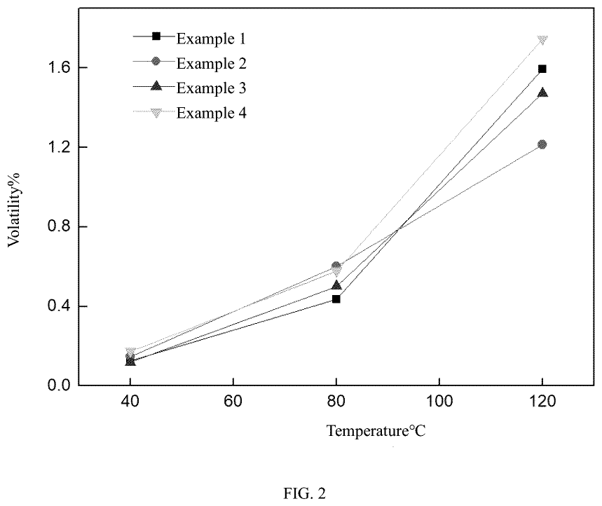

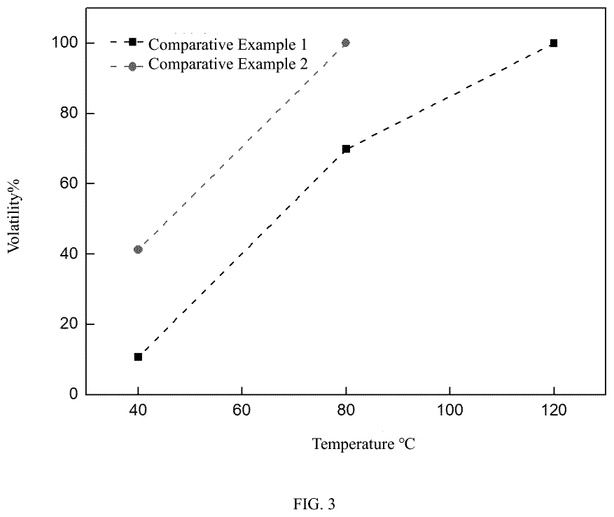

Volatilization curves of the organic slurries with a gradient volatilization rate prepared in Examples 1˜4 and the organic slurries prepared in Comparative Examples 1 and 2 under insulation at 40° C., 80° C., and 120° C. for 2 hours were sequentially tested. The test results were shown in FIG. 2 and FIG. 3. It can be seen from FIG. 2 that the evaporation rates in Examples 1˜4 were extremely low at 40° C. and less than 0.15% to ensure storage and printing stability; and when the temperature increased to 120° C., the volatilization rates significantly increased to ensure drying efficiency. It can be seen from FIG. 3 that the organic slurries in Comparative Examples 1 and 2 had extremely high volatilization rates at high temperatures, but their volatilization rates exceeded 10% and 40% respectively at 40° C., which seriously affected the printing stability of the organic slurries and were not conducive to continuous production.

The organic slurry prepared in Example 1 was applied to the surface of a neodymium iron boron magnet by screen printing. After drying at 120° C. for 10 minutes, the coating on the magnet was observed with a metallographic microscope. After drying, the coating had good uniformity, no obvious cracks or bubbles, and good bonding with a substrate, showing that the volatilization rate of the organic matter in the drying process was appropriate.

The prepared organic slurries prepared in Examples 1-8 were applied to surfaces of neodymium iron boron magnets by screen printing. After drying, the neodymium iron boron magnets were thermally treated at 900° C. for 5 hours and then tempered at 500° C. for 3 hours. The tested properties of the magnets were as shown in Table 2. The decrease in residual magnetism after diffusion was less than 0.3 kGs. It can be seen that the organic slurry did not affect the subsequent diffusion process.

TABLE 2

| | Decrease in residual |
|---|---|
| Serial number | magnetism/kGs |
| Example 1 | 0.23 |
| Example 2 | 0.26 |
| Example 3 | 0.12 |
| Example 4 | 0.24 |
| Example 5 | 0.20 |
| Example 6 | 0.18 |
| Example 7 | 0.27 |
| Example 8 | 0.09 |

The embodiments of the present application aim to protect an organic slurry with a gradient volatilization rate and a preparation method, which have the following effects:

The organic carrier forms a reticular structure by constructing gradients of organic ingredients and by virtue of strong interaction of grinding, thereby ensuring that the room temperature volatilization rate is less than 0.05%/h and the high temperature volatilization rate is greater than 1.2%/h at 120° C., and achieving gradient volatilization of the slurry. The prepared organic slurry with a gradient volatilization rate has a low volatilization rate at room temperature, which can effectively prevent problems such as screen blockage and uneven printing caused by volatilization of the organic solvent during printing; and the organic slurry has a high volatilization rate and short curing time at a high temperature, which can significantly shorten drying time, improve processing efficiency, and reduce the content of oxygen, carbon, and other impurities entering a magnet in curing and subsequent heat treatment stages.

It should be understood that the above-mentioned specific implementations of the present application are merely used for illustrating or interpreting the principle of the present application, rather than limiting the present application. Therefore, any modifications, equivalent substitutions, improvements, and the like made without deviating from the spirit and scope of the present application shall fall within the scope of protection of the present application. Moreover, the appended claims of the present application are intended to cover all variations and modifications falling within the scope and boundary of the appended claims or within equivalent forms of the scope and boundary.

What is claimed is:

1. An organic slurry with a gradient volatilization rate, comprising a rare earth powder, an organic solvent, a resin, a dispersant, and/or an anti-settling agent, and/or a synergist, weight percentages of which being as follows:
rare earth powder 50%-90%;
organic solvent 8%-50%;
resin 0.4%-6%;
dispersant 0%-5%; and
anti-settling agent 0%-3%; and
synergist 0%-3%.

2. The organic slurry with a gradient volatilization rate according to claim 1, wherein the rare earth powder comprises one or two of a pure metal powder containing a heavy rare earth element, an alloy powder containing a heavy rare earth or light rare earth element, and a heavy rare earth powder of a hydride, fluoride or oxide containing a heavy rare earth element.

3. The organic slurry with a gradient volatilization rate according to claim 2, wherein the pure metal powder comprises one or two or more of Tb, Dy, Ho, and Gd; and
the alloy powder is REₓM_{y} by mass percentage, wherein RE is one or two or more of Tb, Dy, Ho, Gd, Pr, Nd, La, Ce, and Y; M is one or two or more of Ga, Cu, Al, Ni, and Fe; 60≤x≤95, and 5≤y≤40.

4. The organic slurry with a gradient volatilization rate according to claim 1, wherein that the rare earth powder has a particle size D50 of less than 3 μm.

5. The organic slurry with a gradient volatilization rate according to claim 2, wherein the organic solvent comprises one or two or more of propylene glycol phenyl ether, DBE, methyl isobutyl ketone, and propylene glycol methyl ether acetate.

6. The organic slurry with a gradient volatilization rate according to claim 5, wherein the resin comprises one or two or more of ethyl cellulose, polyvinyl butyral, acrylic resin, vinyl chloride-vinyl acetate copolymer resin, polyester resin, and polyurethane.

7. The organic slurry with a gradient volatilization rate according to claim 6, wherein the dispersant comprises one or two or more of polyvinyl butyral, polyethylene pyrrolidone, sodium polyacrylate, and polyethylene amide.

8. The organic slurry with a gradient volatilization rate according to claim 7, wherein the anti-settling agent comprises one or two or more of polyamide wax, polyethylene wax, organic bentonite, and fumed silica.

9. The organic slurry with a gradient volatilization rate according to claim 8, wherein the synergist comprises one or two or more of modified polyhydroxycarboxylate, BYK-SYNERGIST 2105, and BYK-SYNERGIST 2100.

10. The organic slurry with a gradient volatilization rate according to claim 8, wherein the weight percentage of each ingredient is as follows:
pure metal powder 65%-75%;
one or two or more of propylene glycol phenyl ether, DBE, and propylene glycol methyl ether acetate 10%-30%;
one or two or more of ethyl cellulose, polyvinyl butyral, and polyester resin 0.4%-4%;
one or two or more of polyethylene glycol, polyethylene pyrrolidone, and polyethylene amide 0%-3%; and
one or two or more of modified polyhydroxycarboxylate, BYK-SYNERGIST 2105, and BYK-SYNERGIST 2100 0%-2%.

11. The organic slurry with a gradient volatilization rate according to claim 8, wherein the weight percentage of each ingredient is as follows:
alloy powder 70%-80%;
one or two or more of propylene glycol phenyl ether, DBE, and propylene glycol methyl ether acetate 20%-30%;
one or two or more of acrylic resin, polyurethane, and polyester resin 0.4%-5%;
one or two or more of polyethylene glycol, polyethylene pyrrolidone, and polyethylene amide 0%-3%; and
one or two of polyamide wax and polyethylene wax 0%-2%; and
one or two or more of modified polyhydroxycarboxylate, BYK-SYNERGIST 2105, and BYK-SYNERGIST 2100 0%-2%.

12. The organic slurry with a gradient volatilization rate according to claim 8, wherein the weight percentage of each ingredient is as follows:
heavy rare earth powder 60%-80%;
one or two of DBE and propylene glycol methyl ether acetate 10%-30%;
one or two or more of vinyl chloride-vinyl acetate copolymer resin, polyester resin, and polyurethane 0.4%-4%;
one or two or more of polyethylene glycol, polyethylene pyrrolidone, and polyethylene amide 0%-3%; and
one or two of polyamide wax and polyethylene wax 0%-2%; and
one or two or more of modified polyhydroxycarboxylate, BYK-SYNERGIST 2105, and BYK-SYNERGIST 2100 0%-2%.

13. A preparation method for the organic slurry with the gradient volatilization rate according to claim 1, comprising:
weighing a rare earth powder, an organic solvent, a resin, a dispersant, and/or an anti-settling agent, and/or a synergist by weight percentage;
sequentially adding the weighed rare earth powder, organic solvent, resin, dispersant, and/or anti-settling agent, and/or synergist into a mixer, stirring at a constant temperature of 20-70° C. and a speed of 600 r/min-1200 r/min for 0.25-6 hours, and then cooling to room temperature to obtain an organic carrier;
adding the organic carrier and the weighed rare earth powder into a vacuum high-speed disperser, and dispersing at a high speed of 1000 r/min-4000 r/min for 0.25-1 hour to obtain a crude organic slurry; and
transferring the crude organic slurry to a gap adjustable three-roll grinder, and grinding 1-3 times to obtain a fine organic slurry.
